(19) United States
(12) Patent Application Publication
(10) Pub. No.: US 2014/0351718 A1
(43) Pub. Date: Nov. 27, 2014

(54) INFORMATION PROCESSING DEVICE, INFORMATION PROCESSING METHOD, AND COMPUTER-READABLE MEDIUM

(71) Applicant: FUJI XEROX Co., Ltd., Tokyo (JP)

(72) Inventors: Yuki NAKAMORI, Kanagawa (JP); Kazunori HORIKIRI, Kanagawa (JP); Nobuyuki YAMAZOE, Kanagawa (JP); Yusuke KANO, Kanagawa (JP)

(73) Assignee: FUJI XEROX Co., Ltd., Tokyo (JP)

(21) Appl. No.: 14/146,436

(22) Filed: Jan. 2, 2014

(30) Foreign Application Priority Data
May 24, 2013 (JP) 2013-109654

(51) Int. Cl. H04L 29/06

(52) U.S. Cl. CPC H04L 65/403
USPC 715/753

(57) ABSTRACT

An information processing device includes an acquiring unit that acquires position information, being information indicating a position of a participant, an extracting unit that processes sticky information being displayed on a shared screen, and extracts sticky information created by a participant near the shared screen, on the basis of position information acquired by the acquiring unit, and a transmitting unit that transmits sticky information extracted by the extracting unit to a participant device as sticky information to display in order to associate sticky information created by a participant on the participant device.

### CROSS-REFERENCE TO RELATED APPLICATIONS

This application is based on and claims priority under 35 USC 119 from Japanese Patent Application No. 2013-109654 filed May 24, 2013.

### BACKGROUND

### Technical Field

The present invention relates to an information processing device, an information processing method, and a computer-readable medium.

### SUMMARY

According to an aspect of the invention, there is provided an information processing device including an acquiring unit that acquires position information, being information indicating a position of a participant, an extracting unit that processes sticky information being displayed on a shared screen, and extracts sticky information created by a participant near the shared screen, on the basis of position information acquired by the acquiring unit, and a transmitting unit that transmits sticky information extracted by the extracting unit to a participant device as sticky information to display in order to associate sticky information created by a participant on the participant device.

### BRIEF DESCRIPTION OF THE DRAWINGS

Exemplary embodiments of the present invention will be described in detail based on the following figures, wherein:

FIG. 1 is a schematic module configuration diagram for an exemplary configuration according to the first exemplary embodiment;

FIG. 2 is an explanatory diagram illustrating an exemplary system configuration in the case of realizing the exemplary embodiments;

FIGS. 3A and 3B are explanatory diagrams illustrating an example of a conference room or the like used by the exemplary embodiments;

FIG. 4 is an explanatory diagram illustrating an exemplary display of a shared screen according to the exemplary embodiments;

FIG. 5 is a flowchart illustrating an exemplary process according to the first exemplary embodiment;

FIG. 6 is a flowchart illustrating an exemplary process according to the first exemplary embodiment;

FIG. 7 is an explanatory diagram illustrating an exemplary data structure of a sticky information table;

FIG. 8 is an explanatory diagram illustrating an exemplary data structure of a board information table;

FIG. 9 is an explanatory diagram illustrating an exemplary data structure of an active sticky table;

FIG. 10 is an explanatory diagram illustrating an exemplary display of a client screen according to the first exemplary embodiment;

FIG. 11 is an explanatory diagram illustrating an exemplary display of a shared screen indicating a processing result according to the first exemplary embodiment;

FIG. 12 is a schematic module configuration diagram for an exemplary configuration according to the second exemplary embodiment;

FIG. 13 is a flowchart illustrating an exemplary process according to the second exemplary embodiment;

FIGS. 14A to 14F are explanatory diagrams illustrating an example of arrangement information according to the second exemplary embodiment;

FIG. 15 is an explanatory diagram illustrating an exemplary display of a shared screen indicating a processing result according to the second exemplary embodiment;

FIG. 16 is an explanatory diagram illustrating an exemplary display of a shared screen indicating a processing result according to the second exemplary embodiment;

FIG. 17 is an explanatory diagram illustrating an exemplary data structure of an arrangement information list; and

FIG. 18 is a block diagram illustrating an exemplary hardware configuration of a computer that realizes an exemplary embodiment.

### DETAILED DESCRIPTION

Hereinafter, various exemplary embodiments related to realizing the present invention will be described by way of example on the basis of the drawings.

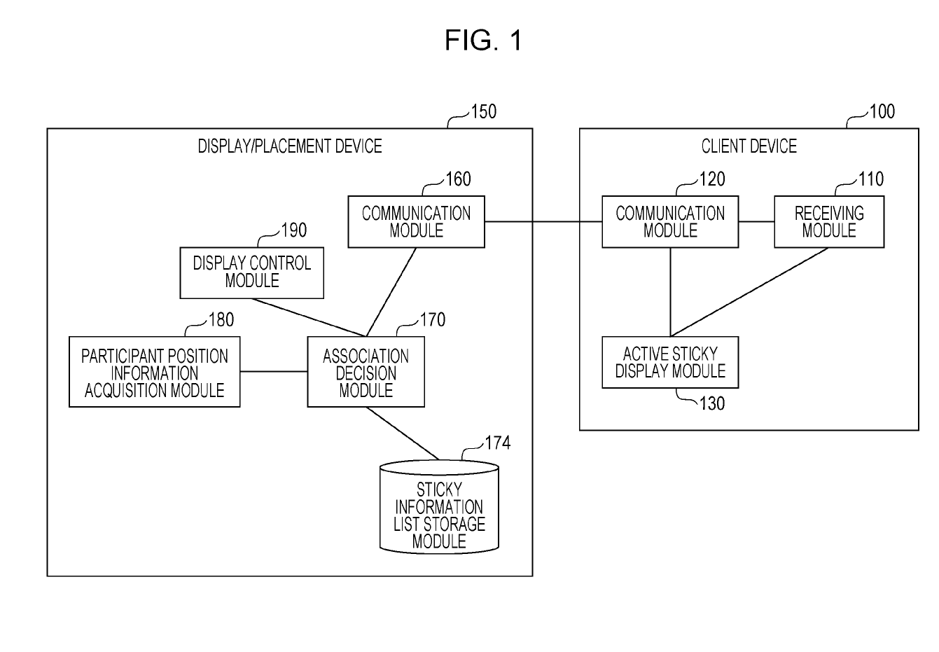

FIG. 1 illustrates a schematic module configuration for an exemplary configuration according to the first exemplary embodiment.

Note that the term module refers to components such as software (computer programs) and hardware which are typically capable of being logically separated. Consequently, the term module in the exemplary embodiment not only refers to modules in a computer program, but also to modules in a hardware configuration. Thus, the exemplary embodiment also serves as a description of a computer program (a program that causes a computer to execute respective operations, a program that causes a computer to function as respective units, or a program that causes a computer to realize respective functions), a system, and a method for inducing functionality as such modules. Note that although terms like “store” and “record” and their equivalents may be used in the description for the sake of convenience, these terms mean that a storage apparatus is made to store information or that control is applied to cause a storage apparatus to store information in the case where the exemplary embodiment is a computer program. Also, while modules may be made to correspond with function on a one-to-one basis, some implementations may be configured such that one program constitutes one module, such that one program constitutes multiple modules, or conversely, such that multiple programs constitute one module. Moreover, multiple modules may be executed by one computer, but one module may also be executed by multiple computers in a distributed or parallel computing environment. Note that a single module may also contain other modules. Also, the term “connection” may be used hereinafter to denote logical connections (such as the transfer of data and referential relationships between instructions and data) in addition to physical connections. The term “predefined” refers to something being determined prior to the processing in question, and obviously denotes something that is determined before a process according to the exemplary embodiment starts, but may also denote something that is determined after a process according to the exemplary embodiment has started but before the processing in question, according to conditions or states at that time, or according to conditions or states up to that time. In the case of multiple “predefined values”, the predefined values may be respectively different values, or two or more values (this obviously also includes the case of all values) which are the same. Additionally, statements to the effect of “B is conducted in the case of A” are used to denote that a determination is made regarding whether or not A holds true, and B is conducted in the case where it is determined that A holds true. However, this excludes cases where the determination of whether or not A holds true may be omitted.

Also, the terms “system” and “apparatus” not only encompass configurations in which multiple computers, hardware, or apparatus are connected by a communication medium such as a network (including connections that support 1-to-1 communication), but also encompass configurations realized by a single computer, hardware, or apparatus. The terms “apparatus” and “system” are used interchangeably. Obviously, the term “system” does not include merely artificially arranged social constructs (social systems).

Also, every time a process is conducted by each module or every time multiple processes are conducted within a module, information to be processed is retrieved from a storage apparatus, and the processing results are written back to the storage apparatus after the processing. Consequently, description of the retrieval from a storage apparatus before processing and the writing back to a storage apparatus after processing may be reduced or omitted in some cases. Note that the storage apparatus herein may include hard disks, random access memory (RAM), an auxiliary or external storage medium, storage apparatus accessed via a communication link, and registers, etc. inside a central processing unit (CPU).

A display/placement device 150, which is an information processing device according to the exemplary embodiments, pastes and displays sticky information (also called electronic sticky notes or electronic cards) transmitted from a client device 100 on a board, and as illustrated by example in FIG. 1, includes a communication module 160, an association decision module 170, a sticky information list storage module 174, a participant position information acquisition module 180, and a display control module 190. Also, a client device 100 connected to the display/placement device 150 via a communication link includes a receiving module 110, a communication module 120, and an active sticky display module 130. The communication link may be wired or wireless.

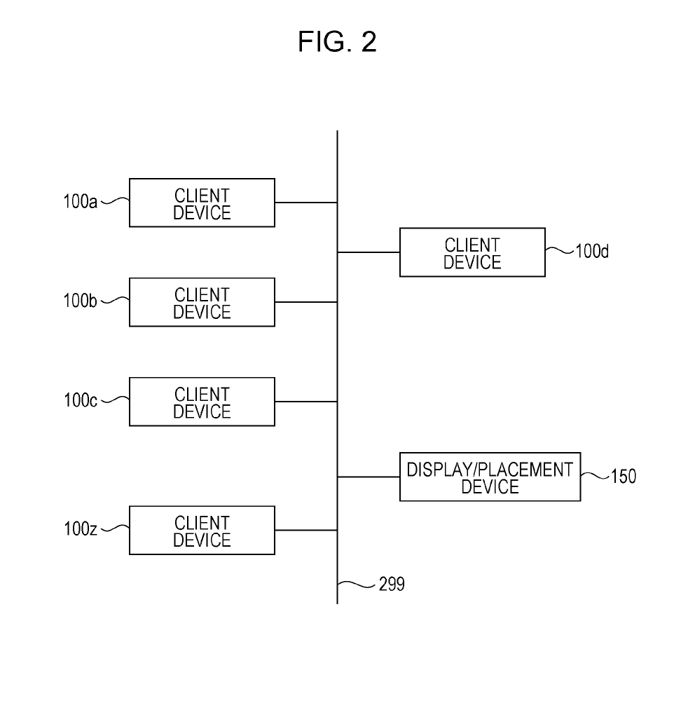

The display/placement device 150 is utilized during a meeting (such as a conference, brainstorming session, or review session) conducted by a facilitator (generally one person) and multiple participants using sticky information. A participant uses a client device (such as the client device 100) as a participant device to create sticky information stating an idea or the like. Typically, as illustrated by example in FIG. 2, there are multiple client devices 100, such as a client device 100a, a client device 100b, and a client device 100c (hereinafter collectively called the client device 100). In addition, the display/placement device 150 receives sticky information from a client device 100, and pastes that sticky information onto a board. The facilitator uses a shared screen, which is the display output of the display/placement device 150, and proceeds with the meeting by, for example, determining or modifying the position of sticky information, collecting sticky information together (also referred to as associating or grouping first sticky information and second sticky information), or creating sticky information him- or herself on the board. Note that in the exemplary embodiments, the participants include the facilitator.

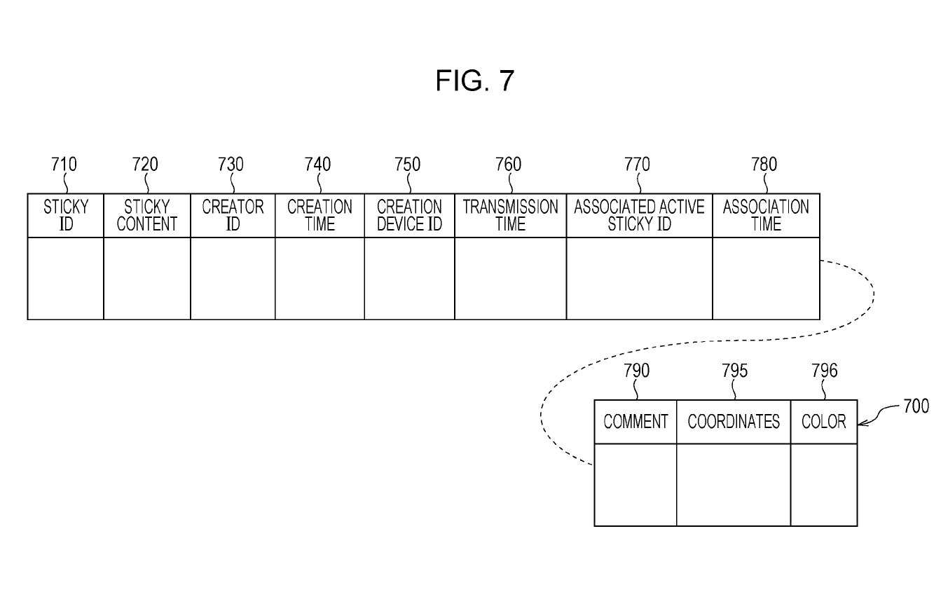

The communication module 160 is connected to the association decision module 170 and the communication module 120 of the client device 100. The communication module 160 transmits active sticky information (including identification information and content information) extracted by the association decision module 170 to a client device 100. The communication module 160 may also transmit screen information of a board created by the display control module 190 (such as the content displayed by the display control module 190) and the like. The communication module 160 receives identification information that identifies sticky information transmitted from a client device 100 (sticky information that a participant created using a client device 100 (first sticky information)) and active sticky information associated with that sticky information (second sticky information). In other words, there are at least two types of information received at this point, these two being (1) sticky information (first sticky information) itself, and (2) identification information of associated active sticky information. Obviously, the identification of active sticky information that is received is included in the identification information of active sticky information extracted by the association decision module 170 (in other words, the identification information of active sticky information transmitted to a client device 100). Note that active sticky information is sticky information that is highly likely to be discussed at the meeting. Consequently, newly created sticky information has a high likelihood of being associated with that active sticky information. In addition, the communication module 160 may also receive (1) sticky information (first sticky information) itself. In this case, the association decision module 170 associates the received sticky information (first sticky information) with any of the active sticky information. Note that, as a specific example, the sticky information itself refers to the sticky information table 700 discussed later using FIG. 7.

The association decision module 170 is connected to the communication module 160, the sticky information list storage module 174, the participant position information acquisition module 180, and the display control module 190. The association decision module 170 processes sticky information being displayed on a shared screen, and extracts sticky information that a participant created near that shared screen, on the basis of position information acquired by the participant position information acquisition module 180. Subsequently, the association decision module 170 transmits, to a client device 100 via the communication module 160, sticky information extracted by the association decision module 170 as sticky information (active sticky information) to display in order to associate sticky information created by a participant on that client device 100 (that is, a participant device). Note that the process of extracting sticky information created by a participant may be conducted specifically by extracting a sticky information ID from a participant ID using the sticky information table 700.

In addition, in the case in which a participant near a shared screen moves away from that shared screen, the association decision module 170 may also extract sticky information created by that participant. Subsequently, the association decision module 170 may transmit, to a client device 100 via the communication module 160, the extracted sticky information so as to indicate sticky information to be removed from the client device 100 from among the sticky information already transmitted.

In addition, the association decision module 170 may extract sticky information being displayed on a shared screen and selected by a participant as active sticky information. Selecting refers to a state in which a participant touching sticky information, and that touch is sensed, for example.

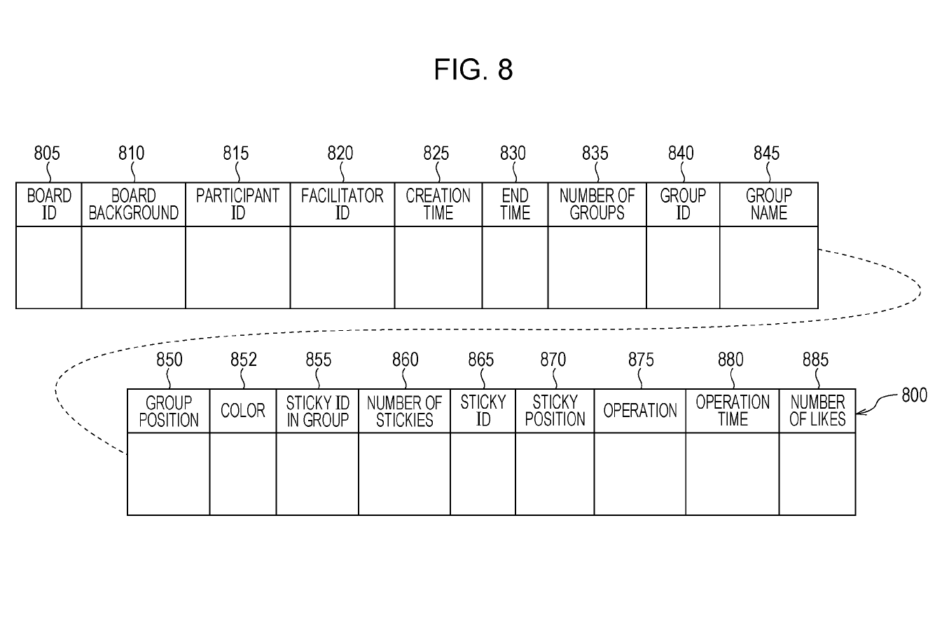

In addition, the association decision module 170 may also process sticky information being displayed on a shared screen, and extract sticky information on the basis of attribute information for that sticky information. Attribute information for sticky information is a transmission time in the transmission time field 760 and a color in the color field 796 within the sticky information table 700 discussed later using FIG. 7, a number of likes in a number of likes field 885 within a board information table 800 discussed later using FIG. 8, or the like. In the case in which these attributes are predetermined values (including ranges), the corresponding sticky information may also be extracted as active sticky information. In addition, the association decision module 170 may also extract sticky information having an attribute close to the value of an attribute of the above sticky information selected by a participant. Herein, an “attribute with a close value” refers to a state in which the difference between the value of an attribute of sticky information selected by a participant and the value of an attribute of sticky information being processed is less than or equal to (or simply less than) a predetermined value.

In addition, in the case of transmitting sticky information to a client device 100 for display, the association decision module 170 may add a period during which to display sticky information on that client device 100. After the display period elapses, the client device 100 removes that sticky information from the display screen of that client device 100. Herein, the display period may be specified with a time (years, months, days, hours, minutes, seconds, fractions of a second, or some combination thereof; this applies similarly hereinafter) indicating a range such as the number of seconds elapsing since starting the display, or with a time at which to end the display. Also, the length of the period may be set to a length based on an attribute of the sticky information (active sticky information) to transmit. For example, the length of the period may be set to a length according the number of sets of sticky information associated with the sticky information to transmit. More specifically, the length of the period may be calculated in proportion to the number of sets of associated sticky information. Also, the length of the period may be set to a length according to the transmission time of the sticky information to transmit. More specifically, the length of the period may be set longer to the extent that the transmission time is close to the current time. Note that the attributes of sticky information A to transmit may include, besides the attributes of the sticky information A, the attributes of sticky information B associated with the sticky information A. Furthermore, the attributes of the sticky information A may also include the attributes of additional associated sticky information, such as the attributes of sticky information C associated with the sticky information B. Consequently, a length according to the transmission time of the sticky information B associated with the sticky information A to transmit (or in the case of multiple sticky information B, a statistical value thereof (such as the average, the mode, or the median)) is also included in “a length based on an attribute of the sticky information to transmit”.

In addition, in correspondence with the above transmission, the association decision module 170 may receive, from a client device 100, first sticky information and identification information that identifies second sticky information associated with the first sticky information. Subsequently, the association decision module 170 may associate (group) the first sticky information with the second sticky information of the received identification information.

In addition, in correspondence with the above transmission, the association decision module 170 may receive identification information of first sticky information from a client device 100. Subsequently, on the basis of the attributes of the first sticky information of the received identification information, the association decision module 170 may associate the first sticky information with any of the second sticky information from among the transmitted sticky information discussed earlier (active sticky information). Herein, the decision method for second sticky information may involve comparing the attributes of the first sticky information to the attributes of the second sticky information, and setting sticky information with close attribute values to the second sticky information. More specifically, the second sticky information may be: (1) sticky information sent immediately before the time at which the first sticky information started to be created. For such sticky information, it is sufficient to compare the value of the creation time field 740 in the sticky information table 700 for the first sticky information to the time at which the active sticky information was transmitted. (2) Among the active sticky information, sticky information with the same color as the first sticky information. For such sticky information, it is sufficient to compare the values of the color field 796 in the sticky information table 700 for the first sticky information and the active sticky information.

The sticky information list storage module 174 is connected to the association decision module 170. The sticky information list storage module 174 stores a sticky information table 700, a board information table 800, and an active sticky table 900, for example.

The receiving module 110 creates the sticky information table 700, the created sticky information table 700 is transmitted to the display/placement device 150, and information is stored in fields such as the comment field 790 and the coordinates field 795 by the display/placement device 150 (particularly the display control module 190 or the like). FIG. 7 is an explanatory diagram illustrating an exemplary data structure of the sticky information table 700. The sticky information table 700 includes a sticky ID field 710, a sticky content field 720, a creator ID field 730, a creation time field 740, a creation device ID field 750, a transmission time field 760, an associated active sticky ID field 770, an association time field 780, a comment field 790, a coordinates field 795, and a color field 796. The sticky ID field 710 stores a sticky identification (ID) for uniquely specifying sticky information in the exemplary embodiment. The sticky content field 720 stores text, graphics, or the like stated by a participant in the sticky information. For example, the sticky content may be a character code sequence, vector data indicating the path of a finger or pen, or the file name of a file storing such data. The creator ID field 730 stores a participant ID for uniquely specifying the participant who created that sticky information in the exemplary embodiment. The creation time field 740 stores the time at which that sticky information was created (the time at which creation was completed, the time at which creation was started, or both). The creation device ID field 750 stores a creation device ID for uniquely specifying the device on which that sticky information was created in the exemplary embodiment. The transmission time field 760 stores the time at which that sticky information was transmitted. The associated active sticky ID field 770 stores second sticky information related to that sticky information (the first sticky information). The “second sticky information” is sticky information that is already pasted onto the board. The information may be the sticky ID of second sticky information specified by the participant who created by the first sticky information, and the sticky ID of that second sticky information is specified in the case where, for example, the content of the first sticky information was proposed by looking at the second sticky information, and the participant thinks that the content should be positioned near the second sticky information. Note that “NULL” is stored in the case in which a participant does not specify second sticky information. The association time field 780 stores the time at which the first sticky information was associated with the second sticky information. The comment field 790 stores a comment related to that sticky information. The creator of the comment may be the participant who created the sticky information, another participant, or the facilitator. The coordinates field 795 stores the coordinates (x, y) at which that sticky information is placed. When a sticky is directly pasted onto the board, the coordinates may the coordinates (x, y) of the board. When a sticky belongs to a group, the coordinates may be relative coordinates (x, y) from the start point of the group. The color field 796 stores a color applied to that sticky information. In the case in which a color is applied to sticky information, the display includes setting the background of that sticky information (within a card-shaped rectangle) to that color, for example. Note that a color is determined by participant and facilitator operations.

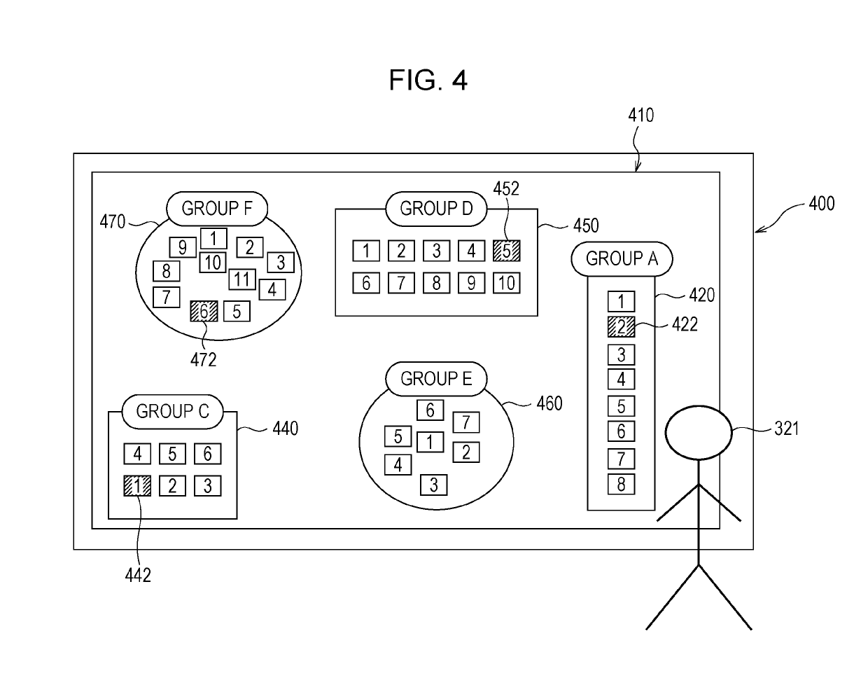

The display/placement device 150 (particularly, the association decision module 170, the display control module 190, and the like) creates a board information table 800. Information related to sticky information associated by the association decision module 170, and groups or the like that are the result of the associating, are stored in the group ID field 840 and subsequent fields. FIG. 8 is an explanatory diagram illustrating an exemplary data structure of the board information table 800. The board information table 800 includes a board ID field 805, a board background field 810, a participant ID field 815, a facilitator ID field 820, a creation time field 825, an end time field 830, a number of groups field 835, a group ID field 840, a group name field 845, a group position field 850, a color field 852, a sticky ID in group field 855, a number of stickies field 860, a sticky ID field 865, a sticky position field 870, an operation field 875, an operation time field 880, and a number of likes field 885. The board ID field 805 stores a board ID for uniquely specifying a board in the exemplary embodiment. The board background field 810 stores a background pattern for the board (such as XY axes or a template image, for example). The participant ID field 815 stores participant IDs of participants using that board. The facilitator ID field 820 stores a facilitator ID of a facilitator using that board. The creation time field 825 stores the creation start time of that board. The end time field 830 stores the creation end time of that board. The number of groups field 835 stores the number of groups forming sets on that board. There exist sets of the group ID field 840, the group name field 845, the group position field 850, the color field 852, and the sticky ID in group field 855, equal to the number of groups. The group ID field 840 stores a group ID for uniquely specifying that group in the exemplary embodiment. The group name field 845 stores a name for that group (such as group A and group B in FIG. 4 and other drawings). The group position field 850 stores the position of that group on the board (XY coordinates on the board, for example). The color field 852 stores a color applied to that group. In the case in which a color is applied to a group, the display includes setting the area of that group to that color, setting sticky information belonging to that group to that color, and displaying the title portion of the group in that color, for example. Note that a color is determined by a facilitator operation. The sticky ID in group field 855 stores sticky IDs of sticky information included as elements in that group. The number of stickies field 860 stores the number of sets of sticky information pasted on that board. There exist sets of the sticky ID field 865, the sticky position field 870, the operation field 875, the operation time field 880, and the number of likes field 885, equal to the number of sets of sticky information. The sticky ID field 865 stores a sticky ID of sticky information pasted onto that board. The sticky position field 870 stores the position of that sticky information on the board (XY coordinates on the board, for example). The operation field 875 stores an operation performed on that sticky information. Examples of operations include selecting, moving, copying, rewriting content, and the like. The operation time field 880 stores the time at which that operation was performed. The number of likes field 885 stores a count of the number of times participants pressed a “Like” button for that sticky information (that is, the number of likes).

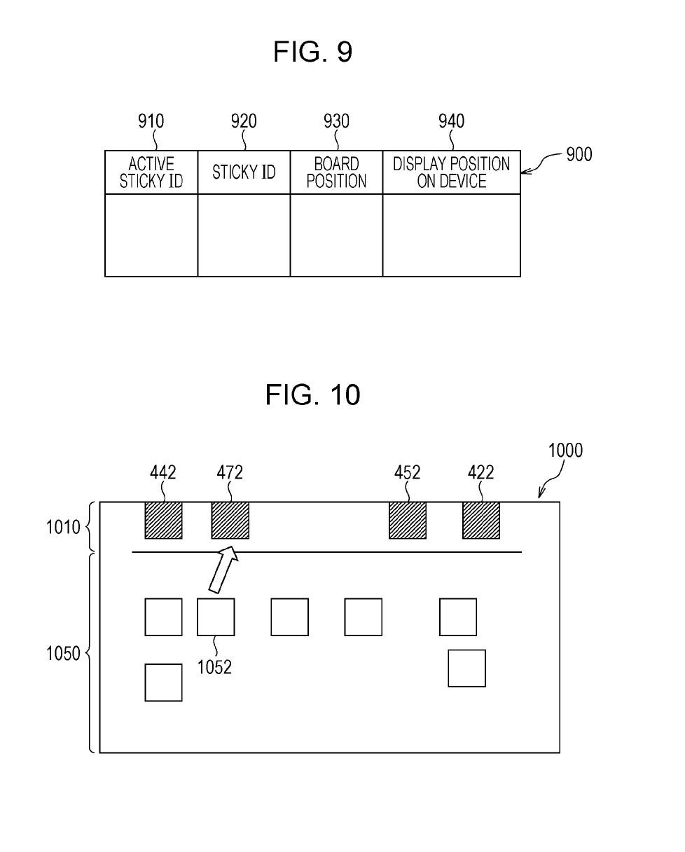

The association decision module 170 creates an active sticky table 900. Subsequently, the active sticky table 900 is transmitted to the display/placement device 150, and used when the active sticky display module 130 presents a display on the display device of a client device 100. Also, the receiving module 110 stores information in the sticky ID field 920. FIG. 9 is an explanatory diagram illustrating an exemplary data structure of the active sticky table 900. The active sticky table 900 includes an active sticky ID field 910, a sticky ID field 920, a board position field 930, and a display position on client field 940. The active sticky ID field 910 stores a sticky ID of sticky information extracted by the association decision module 170 (active sticky information). The sticky ID field 920 stores a sticky ID of sticky information associated with the active sticky information by an associating operation of a participant. The board position field 930 stores position information (x, y) on a board of a shared screen. The display position on client field 940 stores position information (x, y) on a display device of a client device 100. For example, there is stored position information that reflects the x-coordinate of the position information being stored in the board position field 930. Specifically, in the case of using a horizontally extended area like the active sticky display area 1010 of FIG. 10 discussed later, there is stored position information that reflects the x-coordinate of the active sticky information on the board. “Reflecting the x-coordinate on the board” refers, in the case of presenting a reduced display of the board on a display device of a client device 100, to the x-coordinate at which active sticky information on the reduced display of the board is positioned. Consequently, in this case, the positional relationships of the x-coordinates of active sticky information on the board are also maintained on a display device of a client device 100. Obviously, in the case in which the active sticky display area 1010 is a vertically extended area, there is stored position information that reflects the y-coordinate of the active sticky information on the board.

The participant position information acquisition module 180 is connected to the association decision module 170. The participant position information acquisition module 180 acquires position information, which is information indicating the position of a participant. Note that the positions of all participants may not be ascertained. It is sufficient to at least specify participants near the shared screen. “Near” refers being within a predetermined distance from the shared screen. For example, an IC card reader capable of short-range communication (in other words, contactless reading) installed in the shared screen or near the shared screen may read an identification code enabling participant specification from an IC card being carried by that participant near the shared screen, and compute that participant as being positioned near the shared screen. Several such IC card readers may be installed inside a conference room, and position information for a participant may be acquired according to which IC card reader sensed that participant. Note that the configuration is not limited to an IC card, and a mobile device or the like (such as the client device 100) is also acceptable insofar as a participant ID is stored therein. In addition, position information for each participant may also be acquired by communicating with a Global Positioning System (GPS) sensor built into a mobile device or the like.

In addition, in the case in which a participant who was near the shared screen moves away from that shared screen (the case of moving farther away than the above predetermined distance), the participant position information acquisition module 180 ceases to sense that participant, and thus extracts the participant ID that had been sensed up to that point, but ceased to be sensed. The participant ID that ceased to be sensed is passed to the association decision module 170. After that, the association decision module 170 conducts a process to extract sticky information created by the participant with that participant ID, and remove that sticky information from the active sticky information.

The display control module 190 is connected to the association decision module 170. The display control module 190 displays a board (such as a blank white space, XY axes for indicating a coordinate system, or some other pattern that acts as a background) and sticky information pasted onto the board, and displays first sticky information associated by the association decision module 170 near second sticky information. Herein, “near” refers to the first sticky information being within a predetermined distance from the second sticky information, or the first sticky information being within a group to which the second sticky information belongs.

Note that the display/placement device 150 may be, from among the modules discussed earlier, a combination of the participant position information acquisition module 180, the association decision module 170, and the communication module 160, or a combination of the participant position information acquisition module 180, the association decision module 170, the communication module 160, and the display control module 190.

The client device 100 includes a touch panel-style display device and input device, for example, and receives operations using a participant's finger, a pen, or the like so as to create sticky information, select active sticky information as an association target for the created sticky information, and the like. Also, besides a touch panel, input using a keyboard and mouse, speech input using a microphone, image input using a camera, and the like are also acceptable. The sticky information may have a data structure in which card-style information may be managed. The content of the sticky information may be text information, handwritten characters, vector data expressing a graphic or the like, still image information such as a photo, video information or the like, or a combination thereof.

The receiving module 110 is connected to the communication module 120 and the active sticky display module 130. The receiving module 110 passes participant actions with respect to active sticky information displayed on a display device of a client device 100 by the active sticky display module 130 (operations to associate and transmit sticky information created by a participant and active sticky information, operations to transmit sticky information created by a participant) and information related to sticky information created by a participant to the communication module 120 and the display/placement device 150 via a communication link.

The communication module 120 is connected to the receiving module 110, the active sticky display module 130, and the communication module 160 of the display/placement device 150. The communication module 120 communicates with the display/placement device 150, and transmits information passed from the receiving module 110 to the display/placement device 150. In addition, the communication module 120 receives information transmitted from the display/placement device 150, which is passed to the active sticky display module 130 or a relevant module inside the client device 100. For example, the communication module 120 may receive board screen information from the display/placement device 150 (such as the content displayed by the display control module 190), and pass the received board screen information to a display module that presents a display on a display device of the client device 100.

The active sticky display module 130 is connected to the receiving module 110 and the communication module 120. The active sticky display module 130 displays active sticky information extracted by the display/placement device 150 on a display device of the client device 100. For example, the active sticky display module 130 presents a display like the active sticky (1) 442 in the active sticky display area 1010 on a client screen 1000 illustrated by example in FIG. 10 to be discussed later.

FIG. 2 is an explanatory diagram illustrating an exemplary system configuration in the case of realizing the exemplary embodiment. Devices such as a client device 100a, a client device 100b, a client device 100c, a client device 100d, a client device 100z, and the display/placement device 150 are respectively connected via a communication link 299. Although not all devices may be in the same room (such as a conference room), generally the client device 100a and the like used by participants and the display/placement device 150 used by the facilitator are in the same room. The communication link 299 may be a wired link or a wireless link.

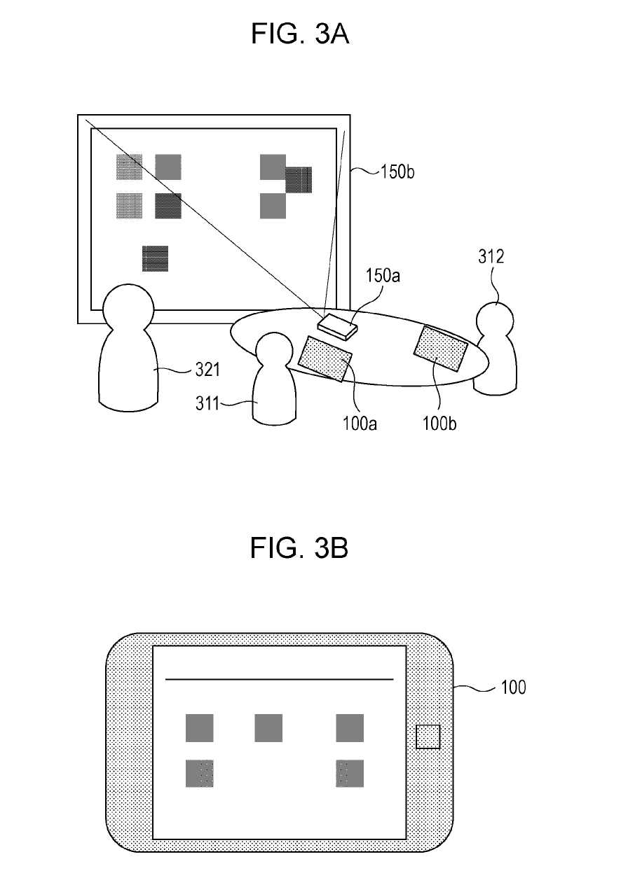

FIGS. 3A and 3B are explanatory diagrams illustrating an example of a conference room or the like used by the exemplary embodiment.

As illustrated in the example in FIG. 3A, participants 311 and 312 and a facilitator 321 are gathered in a conference room or the like. The participant 311 uses the client device 100a, while the participant 312 uses the client device 100b. Generally, each participant is given one client device (such as the client device 100a) which, like the client device 100 illustrated in the example of FIG. 3B, is a tablet device approximately the size of a notebook (such as A4, B5, or from 7 to 10 inches, for example), and is operated using a finger, pen, or the like. Sticky information stating handwritten text, graphics, or the like is created by a participant. Note that a client device is not limited to a tablet device, and may also be a device such as a PC equipped with a keyboard, mouse, and the like.

The display/placement device 150a is a projector, and displays a board. The display/placement device 150a may also be a device equipped with a large screen (a size such as 80 inches, for example). In addition, the display/placement device 150b is an electronic whiteboard that senses the motion of a finger, pen, or the like of a facilitator 321, and receives operations such as the associating (grouping) of sticky information. For example, the display/placement device 150b may be equipped with a pen, and receives an operation with respect to the board and sticky information by sensing that the pen has left a predetermined pen holder (that is, the facilitator 321 has picked up the pen in order to perform an operation), and by sensing the position of the pen tip (such as the pen tip touching the display/placement device 150b). For example, a sensor may be provided in the pen holder (such as a sensor in which a switch turns on/off by the weight of a pen), and may sense which pen from among multiple pens (such as a black pen, a red pen, and a blue pen) is being used. Also, the entire display screen of the display/placement device 150b may be a touch sensor, and may sense touched positions on the display screen. Also, in the present exemplary embodiment, participants near the display/placement device 150b (including the facilitator) are sensed.

FIG. 4 is an explanatory diagram illustrating an exemplary display of a shared screen 400 according to the exemplary embodiment. The shared screen 400 is displayed on the display/placement device 150b illustrated in the example of FIG. 3A.

The shared screen 400 includes a board area 410. Inside the board area 410, besides general sticky information (the small rectangles in FIG. 4), there are displayed a group area A 420, a group area C 440, a group area D 450, a group area E 460, and a group area F 470 in which the sticky information is associated. Additionally, sticky information is moved inside the board area 410 according to an operation by the facilitator 321 who is a participant (such as moving to another group, for example).

Also, sticky information whose association has been specified by the participant of a client device is positioned near active sticky information inside the board area 410. For example, in the case in which the facilitator 321 (a participant) is near the shared screen 400, the active sticky (2) 422, the active sticky (1) 442, the active sticky (5) 452, and the active sticky (6) 472 created by the facilitator 321 are extracted as the active sticky information. Subsequently, in the case in which sticky information transmitted from a client device 100 is associated with any of the active sticky information, the sticky information transmitted from the client device 100 is displayed near the associated active sticky information. Also, multiple sets of sticky information may be grouped (like the group area C 440 and the group area D 450, for example) by an operation of the facilitator 321.

Also, participants are able to “Like” sticky information pasted onto the board. For example, in the case in which a participant approves of the content stated in sticky information, the participant specifies that sticky information and presses a “Like” button displayed on the client device 100 (or presses a “Like” button attached to each set of sticky information). The number of presses is then counted and stored in the number of likes field 885 of the board information table 800. Sticky information for which the number of presses is greater than a predetermined number may be displayed larger than other sticky information.

The display/placement device 150 of the present exemplary embodiment is introduced into such a conference support system.

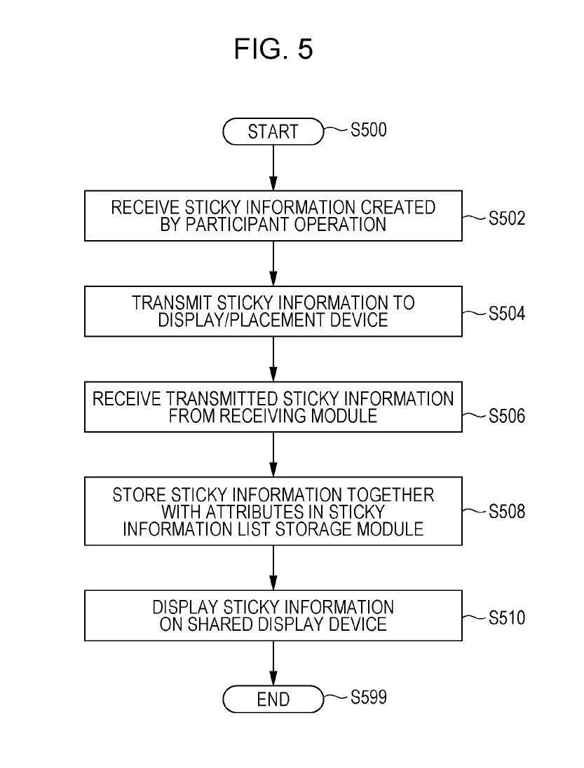

FIG. 5 is a flowchart illustrating an exemplary process according to the first exemplary embodiment.

In step S502, the receiving module 110 receives sticky information created by a participant operation.

In step S504, the communication module 120 transmits sticky information to the display/placement device 150.

In step S506, the communication module 160 receives the sticky information transmitted from the receiving module 110.

In step S508, the association decision module 170 stores the sticky information together with attributes in the sticky information list storage module 174.

In step S510, the display control module 190 displays the sticky information on a shared display device.

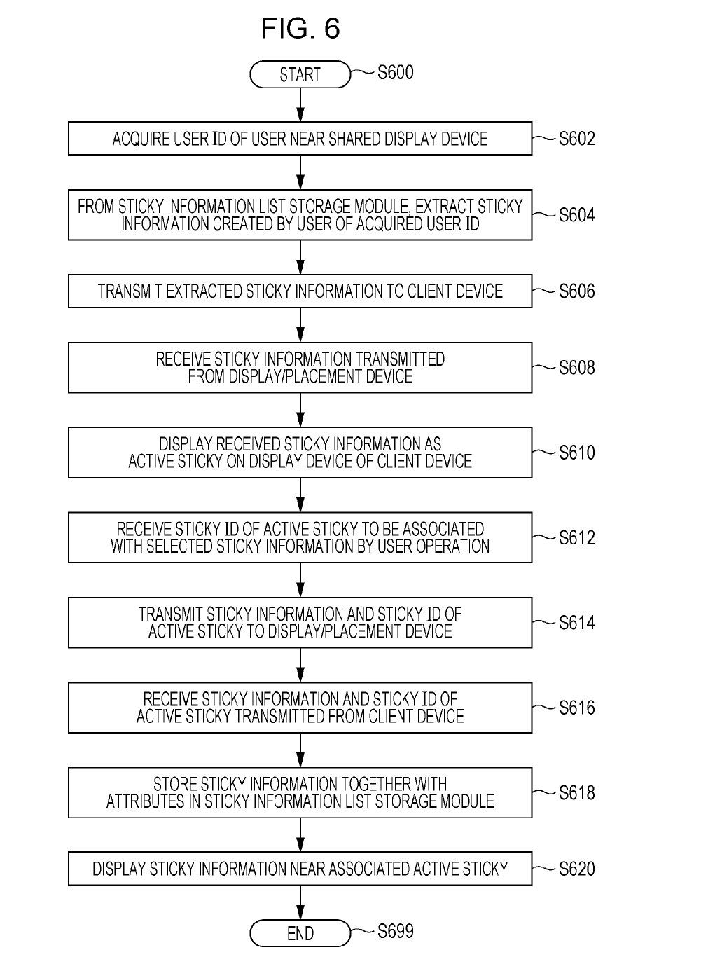

FIG. 6 is a flowchart illustrating an exemplary process according to the first exemplary embodiment.

In step S602, the participant position information acquisition module 180 acquires the user ID (participant ID) of a user near the shared display device. In the example of FIG. 4 discussed earlier, the user ID of the facilitator 321 is acquired.

In step S604, the participant position information acquisition module 180 extracts sticky information created by the user with the acquired user ID from the sticky information list storage module 174. In the example of FIG. 4 discussed earlier, the active sticky (2) 422, the active sticky (1) 442, the active sticky (5) 452, and the active sticky (6) 472 created by the facilitator 321 are extracted. Also, not only sticky information created by the participant with the user ID acquired in step S602, but also sticky information selected by the participant with that user ID may also be extracted. This is because, as a topic of discussion at the meeting, sticky information touched by a participant is also appropriate as active sticky information. For sticky information selected by a participant, the question of which participant created that sticky information is irrelevant to the decision of whether or not to set that sticky information to active sticky information. Such sticky information is set to active sticky information simply by being selected. Note that the conditions to set sticky information to active sticky information may also be that the sticky information is selected sticky information, and is also sticky information created by a participant with a nearby participant ID. As discussed earlier, active sticky information may also be extracted on the basis of attribute information for the sticky information.

Also, a period during which to display sticky information as active sticky information on a client device 100 may also be specified. Obviously, if that period elapses, the client device 100 removes that sticky information from the display device. Note that, as discussed earlier, the length of this period may be determined according to factors such as the number of sets of sticky information associated with the active sticky information.

In step S606, the communication module 160 transmits the extracted sticky information (active sticky information) to a client device 100.

In step S608, the communication module 120 receives the sticky information transmitted from the display/placement device 150.

In step S610, the active sticky display module 130 displays the received sticky information on a display device of the client device 100 as active sticky information. For example, the active sticky (2) 422, the active sticky (1) 442, the active sticky (5) 452, and the active sticky (6) 472 are displayed within the active sticky display area 1010 illustrated in FIG. 10. The client screen 1000 is divided into an active sticky display area 1010 and a created sticky display area 1050. Received active sticky information is displayed in the active sticky display area 1010, while sticky information created by the participant operating the client device 100 is displayed in the created sticky display area 1050. Note that the positional relationships of active sticky information within the active sticky display area 1010 maintain the positional relationships of that active sticky information within the board area 410. In other words, the active sticky (1) 442, the active sticky (6) 472, the active sticky (5) 452, and the active sticky (2) 422 are placed from left to right within the board area 410, and also have a similar placement order in the active sticky display area 1010, with the spacing also maintained in a proportional state.

In step S612, the receiving module 110 receives, via a user operation, the sticky ID of an active sticky with which to associate selected sticky information. For example, in FIG. 10, a moving sticky 1052 is selected and moved to the active sticky (6) 472 (the participant operating the client device 100 intends to associate the moving sticky 1052 with the active sticky (6) 472). Note that, besides an operation of moving sticky information to active sticky information, an attribute of sticky information to transmit to the display/placement device 150 may be set to the same attribute as the active sticky information to associate, for example. For example, the attribute may be color. Specifically, a color is applied to active sticky information being displayed in the active sticky display area 1010, and an operation by an operator sets the color of created sticky information to the same color as the desired active sticky information to associate.

In step S614, the communication module 120 transmits sticky information and the sticky ID of an active sticky to the display/placement device 150. In the above example, the information of the moving sticky 1052 and the sticky ID of the active sticky (6) 472 are transmitted. Note that, in the case in which the color of the sticky information is set to the same color as the desired active sticky information to associate in step S612, that sticky information itself (obviously including the content and attributes) is transmitted.

In step S616, the communication module 160 receives the sticky information and the sticky ID of the active sticky transmitted from the client device 100. In the above example, the information of the moving sticky 1052 and the sticky ID of the active sticky (6) 472 are received. Note that, in the case in which the color of the sticky information is set to the same color as the desired active sticky information to associate in step S612, that sticky information itself is received.

In step S618, the association decision module 170 stores the sticky information together with attributes in the sticky information list storage module 174. The sticky information itself, and information related to the sticky information (attributes) are reflected in and stored in the sticky information table 700, the board information table 800, and the active sticky table 900. Note that, in the case in which the color of the sticky information is set to the same color as the desired active sticky information to associate in step S612, active sticky information having the same attribute as an attribute (color, for example) of the received sticky information is extracted from among the active sticky information transmitted in step S606, and that sticky information and active sticky information are associated together.

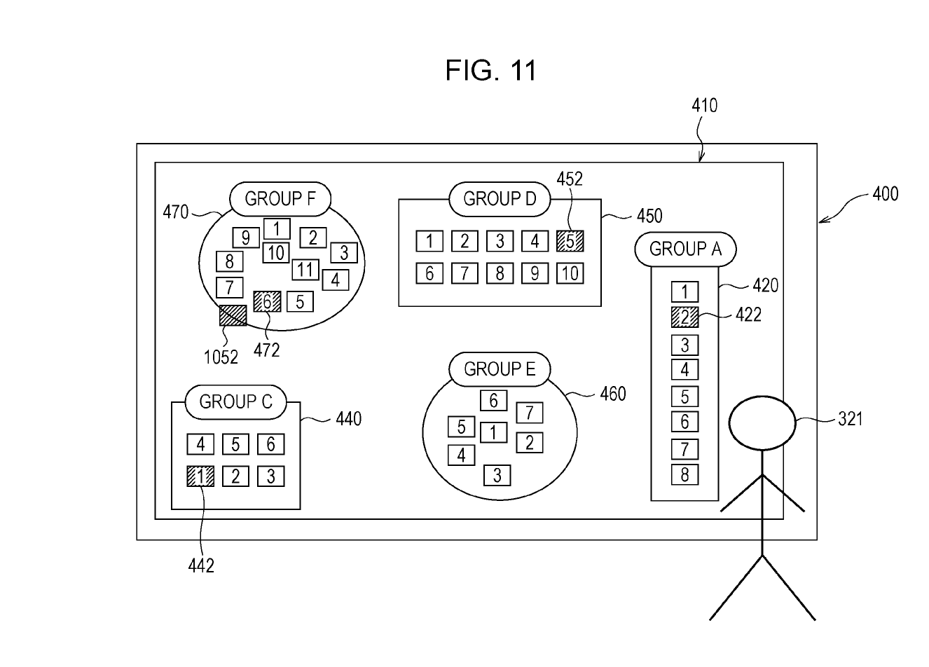

In step S620, the participant position information acquisition module 180 displays the sticky information near the associated active sticky. In the above example, the moving sticky 1052 is displayed near the active sticky (6) 472, as illustrated by the example of FIG. 11.

Also, as a subsequent process, in the case in which the facilitator 321 moves away from the shared display device (the case in which the participant position information acquisition module 180 ceases to detect a participant ID that had been detected up to that point), the association decision module 170 extracts a sticky ID created by the participant with the participant ID that ceased to be detected (that which had been extracted as active sticky information up to that point), and transmits that sticky ID to a client device 100 as the sticky ID of sticky information to remove. The client device 100 removes that which had been displayed as active sticky information up to that point.

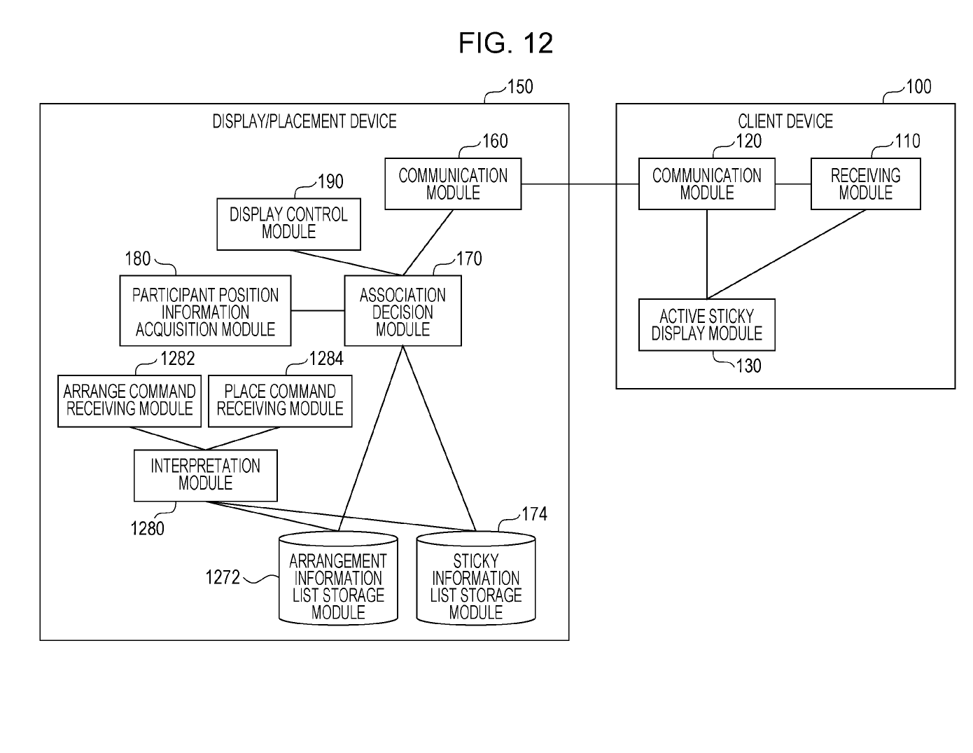

FIG. 12 is a schematic module configuration diagram for an exemplary configuration according to the second exemplary embodiment. An arrange command receiving module 1282, a place command receiving module 1284, an interpretation module 1280, and an arrangement information list storage module 1272 have been added to the display/placement device 150 according to the first exemplary embodiment illustrated by the example in FIG. 1. Note that parts similar to the first exemplary embodiment are denoted with the same reference numerals, and repeated explanation of these parts will be reduced or omitted.

The display/placement device 150 includes a communication module 160, an association decision module 170, an arrangement information list storage module 1272, a sticky information list storage module 174, a participant position information acquisition module 180, a display control module 190, an interpretation module 1280, an arrange command receiving module 1282, and a place command receiving module 1284.

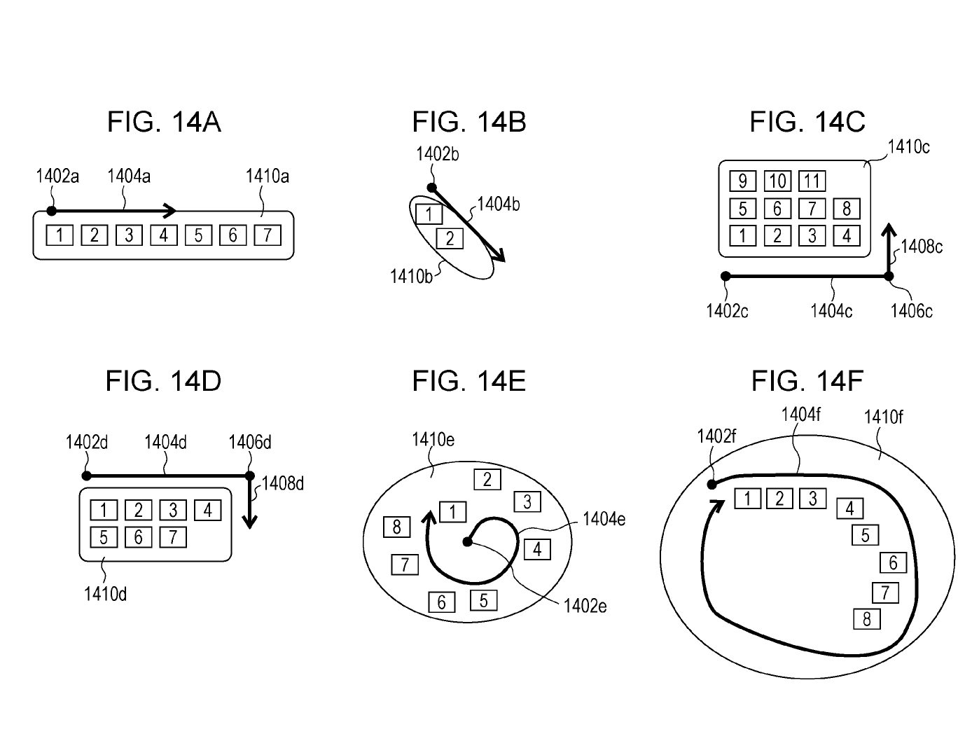

The arrange command receiving module 1282 is connected to the interpretation module 1280. The arrange command receiving module 1282 receives information specifying an area for pasting sticky information onto a board (hereinafter also called arrangement information). The arrangement information at least includes start point information indicating a start point for pasting sticky information within that region, and direction information indicating a direction in which to paste sticky information in order from that start point. Arrangement information is specified by the motion of the facilitator's finger, pen, or the like on the shared screen (hereinafter also called an arrange command), for example. An arrange command refers to an operation indicating a region and order in which to automatically place multiple sets of sticky information. The arrangement information herein includes start point information and direction information. This arrangement information corresponds to the start point 1402a and the direction 1404a in the example in FIG. 14A discussed later, for example.

In addition, the arrange command receiving module 1282 may also receive wrapping point information indicating a wrapping point for the region and second direction information from that wrapping point. The arrangement information in this case becomes start point information, direction information, wrapping point information, and second direction information. For example, this arrangement information corresponds to the start point 1402c, the direction 1404c, the wrapping point 1406c, and the direction 1408c in the example in FIG. 14C discussed later, for example. The wrapping point of an area refers to the point at which the direction changes when drawing lines from the start point of that area towards the direction indicated by the direction information. A change of direction refers to the direction changing by at least a predetermined angle. The predetermined angle may be 70 degrees, for example. The change of direction refers to the direction in which the facilitator's finger, pen, or the like moved from that wrapping point.

The place command receiving module 1284 is connected to the interpretation module 1280. The place command receiving module 1284 receives information related to the movement of sticky information being displayed on the shared screen (hereinafter also called placement information). Placement information is specified by a command that moves sticky information which is performed by the motion of the facilitator's finger, pen, or the like on the shared screen (hereinafter also called a place command), for example.

The interpretation module 1280 is connected to the arrangement information list storage module 1272, the sticky information list storage module 174, the arrange command receiving module 1282, and the place command receiving module 1284. Arrangement information from the arrange command receiving module 1282 is received and stored in the arrangement information list storage module 1272, while placement information is received from the place command receiving module 1284 and reflected in the arrangement information list storage module 1272 and the sticky information list storage module 174.

The interpretation module 1280, in order to decide whether a command is an arrange command or a place command, may make a decision according to whether or not sticky information exists at the position that was first touched. For example, the interpretation module 1280 may decide that a command is a place command in the case in which sticky information does exist at the position that was first touched, and decide that a command is an arrange command in the case in which sticky information does not exist at the position that was first touched (the case in which a background part of the board was touched). Also, either an arrange command mode or a place command mode may be specified, and after the specification, the interpretation module 1280 may decide whether a command is an arrange command or a place command.

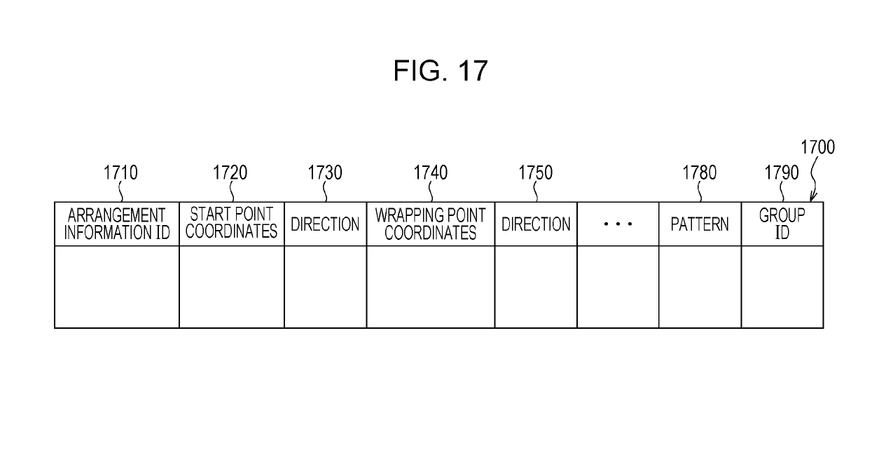

The arrangement information list storage module 1272 is connected to the association decision module 170 and the interpretation module 1280. The arrangement information list storage module 1272 stores a list of arrangement information, such as an arrangement information list 1700, for example. FIG. 17 is an explanatory diagram illustrating an exemplary data structure of the arrangement information list 1700. The arrangement information list 1700 includes an arrangement information ID field 1710, a start point coordinates field 1720, a direction field 1730, a wrapping point coordinates field 1740, a direction field 1750, a pattern field 1780, a group ID field 1790, and the like. The arrangement information ID field 1710 stores an identification (ID) for uniquely identifying arrangement information in the exemplary embodiment. The start point coordinates field 1720 stores the coordinates (x, y) of a start point on the board. The direction field 1730 stores a direction (such as an angle) from a start point. The wrapping point coordinates field 1740 stores the coordinates (x, y) of a wrapping point on the board. The direction field 1750 stores a direction (such as an angle) from a wrapping point. The combination of the wrapping point coordinates field 1740 and the direction field 1750 may also not exist, or exist multiply. The pattern field 1780 stores the shape of an area indicated by arrangement information. The group ID field 1790 stores a group ID indicating a sticky information group included in that area.

The patterns may be the following, for example.

(1) A pattern specifying an area with a start point and a direction (see FIGS. 14A and 14B), in which the shape of the area is like a ray. Consequently, in the case in which new sticky information is added, the new sticky information is placed as an extension of the ray.

(2) A pattern specifying an area with a start point, a direction from the start point, a wrapping point, and a direction from that wrapping point (see FIGS. 14C and 14D), in which the shape of the area is like a square. Consequently, in the case in which new sticky information is added, the new sticky information is placed so as to expand the area in the directions of the direction field 730 or the direction field 750.

(3) A pattern specifying an area with a start point and a direction (see FIGS. 14E and 14F), in which the shape of the area is like an ellipse (including a circle). However, the direction in this case is made up of information that indicates clockwise or counter-clockwise turning, the major axis length of the ellipse, the minor axis length of the ellipse, the tilt of the major axis or minor axis, and outward or inward extension. Outward extension refers to the end point being positioned farther outward from the start point. As illustrated by the example in FIG. 14E, after placing one circumference worth of sticky information on the ellipse, sticky information is placed farther outward, and the area expands due to the placement of sticky information. Inward extension refers to the end point being positioned farther inward than the start point. As illustrated by the example in FIG. 14F, the size of the area is fixed, and after placing one circumference worth of sticky information on the ellipse, sticky information is placed farther inward.

The association decision module 170 is connected to the communication module 160, the arrangement information list storage module 1272, the sticky information list storage module 174, the participant position information acquisition module 180, and the display control module 190. Besides conducting the processes of the association decision module 170 according to the first exemplary embodiment, the association decision module 170 also extracts a group that includes sticky information created by a participant near the shared screen. Subsequently, the association decision module 170 transmits information regarding the extracted group (such as the group name, the group ID, sticky information representative of that group (for example, the sticky information positioned in first place within the group)) to a client device 100 via the communication module 160. Specifically, instead of active sticky information, the association decision module 170 transmits a group that has been extracted by the participant position information acquisition module 180, and to which the active sticky information belongs. Alternatively, active sticky information together with the group to which that active sticky information belongs may be transmitted.

The association decision module 170 associates sticky information pasted onto the board, on the basis of start point information and direction information received by the arrange command receiving module 1282. Herein, “associates sticky information” refers to generating a group whose elements are the multiple sets of sticky information. A sticky information group included within an area formed by start point information and direction information is treated as one group.

In addition, the association decision module 170 may also associate sticky information received by the communication module 160 with any already associated sticky information.

In addition, the association decision module 170 may also associate sticky information received by the communication module 160 with any already associated sticky information, on the basis of action information received together with that sticky information. In this case, the action information may be compared to arrangement information, and the closest arrangement information may be selected.

Also, the association decision module 170 may also associate sticky information within an area determined on the basis of wrapping point information and second direction information.

Also, the association decision module 170 may associate sticky information that has not yet been associated on the basis of either direction information in an area of already associated sticky information (direction information indicating a direction in which to paste sticky information in order from a start point) or second direction information (direction information indicating a direction in which to paste sticky information in order after starting a new line from a wrapping point). Direction information is adopted in the case in which there is no second direction information, while second direction information is adopted in the case in which there is second direction information. Also, “associating on the basis of direction information” refers to expanding an area in that direction, for example. The distance by which to expand may be a predetermined distance, or a distance that is proportional or inversely proportional to the number of sets of associated sticky information within that area (the number of sets of sticky information included in a group). In the case of setting a distance that is proportional to the number of sets of sticky information, groups having more sticky information tend to become larger, whereas in the case of setting a distance that is inversely proportional to the number of sets of sticky information, groups with less sticky information tend to become larger. The question of which method to use may be predetermined, or set according to a specifying operation by the facilitator.

In addition, in correspondence with the above transmission, the association decision module 170 may receive first sticky information from a client device 100. Subsequently, on the basis of the attributes of the first sticky information of the received identification information, the association decision module 170 may associate the first sticky information with any group from among the transmitted groups discussed earlier. Herein, the decision method for the group to associate may involve comparing the attributes of the first sticky information to the attributes of a group, and setting a group with close attribute values as the group to associate. More specifically, the group to associate may be (1) a group sent immediately before the time at which the first sticky information started to be created. For such a group, it is sufficient to compare the value of the creation time field 740 in the sticky information table 700 for the first sticky information to the time at which a group was transmitted from the display/placement device 150. The group to associate may also be (2) among the active sticky information, a group with the same color as the first sticky information. For such a group, it is sufficient to compare the values of the color field 796 in the sticky information table 700 for the first sticky information and the active sticky information to the value of the color field 852 in the board information table 800.

The sticky information table 700 and the board information table 800 stored in the sticky information list storage module 174 may also be as follows. The above group indicates a sticky information group associated by an area specifying operation by the facilitator, but a default group (such as group Z, for example) may also be provided. The default group refers to one that includes, as elements, sticky information pasted onto the board before association is conducted. Consequently, sticky information that was not associated by an area specifying operation by the facilitator is included in the default group. In the case of setting such a default group, the coordinates field 795 of the sticky information table 700 illustrated by the example in FIG. 7 discussed above may be omitted. In other words, the position of unassociated sticky information may also be indicated by the sticky position field 870 of the board information table 800.

The display control module 190 is connected to the association decision module 170. The display control module 190 displays a sticky information group associated by the association decision module 170 so as to indicate the association on the board. Herein, “displaying so as to indicate the association” refers to, for example, displaying lines enclosing an associated sticky information group, applying the same color to an associated sticky information group (obviously, other associated sticky information groups have different colors), or the like. Furthermore, a group name or the like may be displayed near that associated sticky information group. Also, in this case, the position of associated sticky information may be modified in accordance with arrangement information.

Also, the display control module 190, on the basis of direction information in a sticky information group associated by the association decision module 170, may display sticky information received by the communication module 160 on the board at the next position after the last sticky information in that sticky information group.

In addition, the display control module 190 may decide on a position on the board for display sticky information received by the communication module 160, and display the sticky information at that position, on the basis of action information received together with that sticky information.

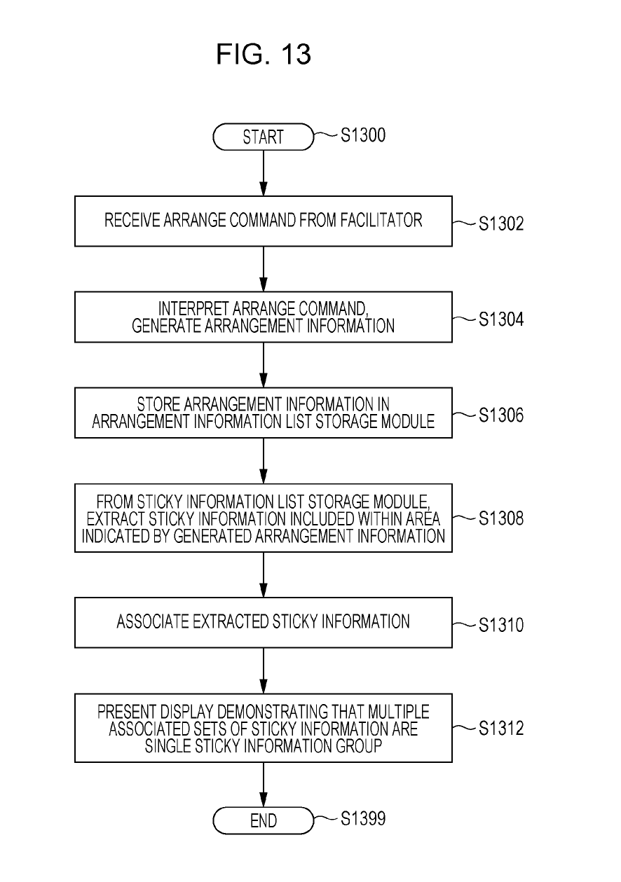

FIG. 13 is a flowchart illustrating an exemplary process according to the second exemplary embodiment.

In step S1302, the arrange command receiving module 1282 receives an arrange command from the facilitator.

In step S1304, the interpretation module 1280 interprets the arrange command, and generates arrangement information. FIGS. 14A to 14F are explanatory diagrams illustrating an example of arrangement information according to the exemplary embodiment. The small rectangles are sets of sticky information being displayed. Arrangement information at least includes start point information and direction information. In the example of FIG. 14A, an area 1410a is formed by a start point 1402a and a direction 1404a. An operation specifying the start point 1402a and the direction 1404a corresponds to an operation that touches the position of the start point 1402a, and then directly moves in the direction 1404a. Also, sticky information near the track left by the operation is associated. Herein, “near” refers to being within a predetermined distance from the coordinates of the track. Obviously, the track may be drawn above the sticky information like in the example of FIG. 14A, or drawn below. Additionally, the lineup of sticky information may be as illustrated by the example of FIG. 14A along the direction 1404a. In addition, the positions of associated sticky information may be arranged. Sticky information is lined up along the direction 1404a, taking a predetermined distance as the interval between each set of sticky information. In the case of adding new sticky information to the group, the new sticky information is placed to the right of the sticky information (7) along the direction 1404a. Consequently, in this case, the sticky information is lined up in a single row. FIG. 14B illustrates a similar example, in which the direction 1404b is diagonally downward to the right. Obviously, the direction information may also be upward, leftward, or the like.

In the example of FIG. 14C, an area 1410c is formed by a start point 1402c, a direction 1404c, a wrapping point 1406c, and a direction 1408c. The start point 1402c and the direction 1404c are the same as the above start point 1402a and the direction 1404a. A direction change in which there is a temporary stop along the track of the direction 1404c and the directions before and after are equal to or greater than a predetermined angle (equal to or greater than 70 degrees, for example) may be sensed. Also, a simple direction change may also be sensed. Additionally, sticky information near the track left by the operation is associated. Sticky information is lined up from left to right as illustrated by the example of FIG. 14C along the direction 1404c. After lining up to the position of the wrapping point 1406c, the row shifts upward in the direction 1408c, as illustrated by the example of FIG. 14C. In the case of adding new sticky information to the group, the new sticky information is placed to the right of the sticky information (11) along the direction 1404c or the direction 1408c. Consequently, in this case, the group becomes a square area in which four sets of sticky information are lined up in the horizontal direction. In other words, there is formed a rectangle, with one edge going from the start point to the wrapping point, that grows in the direction at a right angle to the edge. FIG. 14D illustrates a similar example, in which the direction 1408d is downward. Obviously, as long as the first direction information and the second direction information differ, any combination of directions is possible.

In the example of FIG. 14E, an area 1410e is formed by a start point 1402e and a direction 1404e. In the example of FIG. 14F, an area 1410f is formed by a start point 1402f and a direction 1404f. In the case in which the track of the direction 1404e or the direction 1404f is recognized to be an ellipse, it is sensed whether or not the end point of the direction (the direction 1404e or the direction 1404f) is farther outward on the ellipse compared to the start point (the start point 1402e or the start point 1402f). In the case of sensing that the end point is farther outward as illustrated by the example of FIG. 14E, an area 1410e is formed in which the ellipse grows outward. For the lining up of sticky information, sticky information is placed along the direction 1404e, and after one circumference, is placed farther outward. Conversely, in the case of sensing that the end point is farther inward as illustrated by the example of FIG. 14F, an area 1410f is formed in which the size of the elliptical shape is fixed. For the lining up of sticky information, sticky information is placed along the direction 1404f, and after one circumference, is placed farther inward.

These sensed results are stored in the arrangement information list 1700.

In step S1306, the interpretation module 1280 stores arrangement information (an arrangement information list 1700) in the arrangement information list storage module 1272.

In step S1308, the association decision module 170 extracts sticky information included inside an area indicated by the generated arrangement information from the sticky information list storage module 174 (the board information table 800). As discussed earlier, sticky information near the coordinates of a track may be extracted.

In step S1310, the association decision module 170 associates the extracted sticky information. Specifically, the same group ID is given to the extracted sticky information.

In step S1312, the display control module 190 presents a display demonstrating that the multiple associated sticky information is a single sticky information group. For example, a line enclosing the sticky information belonging to the same group may be drawn as illustrated by example in FIG. 4. Also, sticky information belonging to the same group may be given the same color.

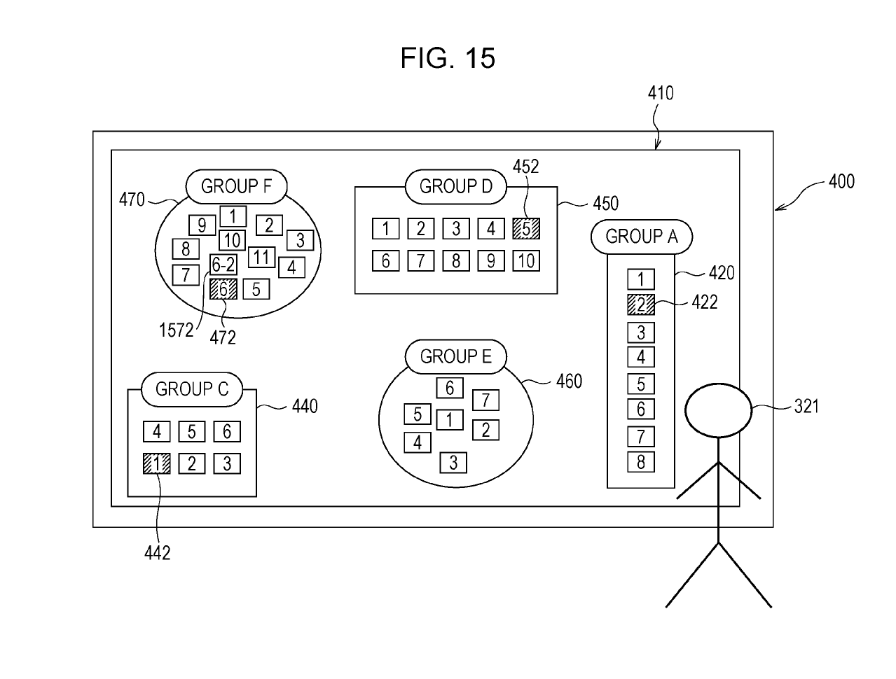

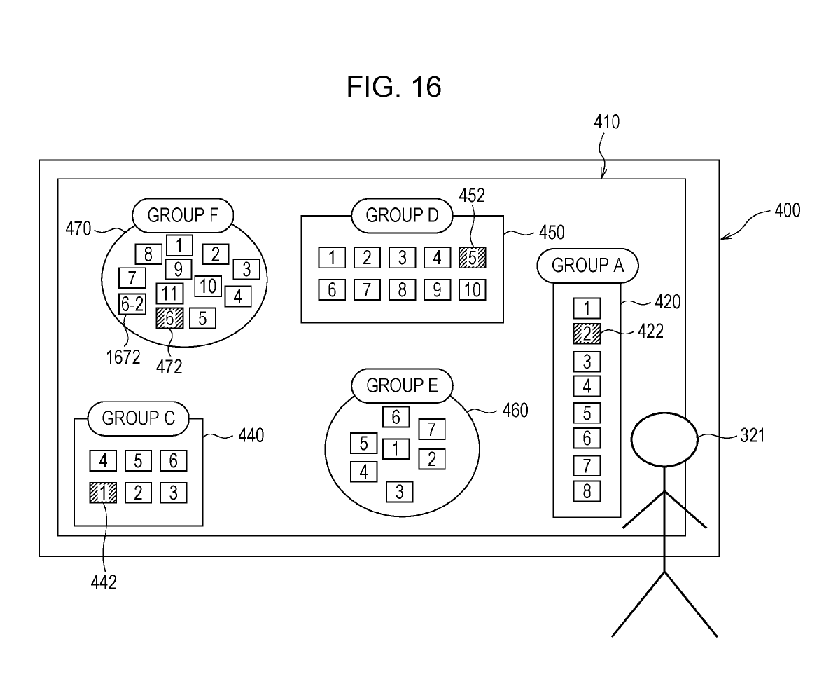

The examples in FIGS. 15 and 16 will now be used to describe how the display control module 190 places newly created sticky information in an area within an associated group.

FIG. 15 is an explanatory diagram illustrating an exemplary display of a shared screen 400 indicating a processing result according to the second exemplary embodiment. Similarly to the example in the first exemplary embodiment, in the case in which the facilitator 321 (a participant) is near the shared screen 400, the active sticky (2) 422, the active sticky (1) 442, the active sticky (5) 452, and the active sticky (6) 472 created by the facilitator 321 are extracted as the active sticky information. Furthermore, the group area A 420, the group area C 440, the group area D 450, and the group area F 470 of the groups to which these active stickies belong are extracted. Additionally, information on the group area A 420, the group area C 440, the group area D 450, and the group area F 470 is transmitted to a client device 100, and a newly created additional sticky (6-2) 1572 is associated with the group area F 470 according to an operation by the operator of the client device 100. The additional sticky (6-2) 1572 is placed at a position in the order specified within the group area F 470, and more specifically, after the sticky (11) within the group area F 470.

FIG. 16 is an explanatory diagram illustrating an exemplary display of a shared screen 400 indicating a processing result according to the second exemplary embodiment. FIG. 16 illustrates an example similar to the above FIG. 15, in which a newly created additional sticky (6-2) 1672 is associated with the group area F 470. The additional sticky (6-2) 1672 is placed at a position immediately after the active sticky (6) 472 specified within the group area F 470, and more specifically, at the position of the sticky (7) within the group area F 470, while the subsequent stickies (7 to 11) are placed in order in the next positions.

The configuration according to the second exemplary embodiment may also be construed as follows. Particularly, the participant position information acquisition module 180 and the association decision module 170 may be combined with these configurations.

(A) An information processing device including:

a first receiving unit that receives information specifying an area for pasting sticky information onto a board, the information being at least start point information indicating a start point for pasting sticky information within that area, and direction information indicating a direction in which to paste sticky information in order from that start point;

an associating unit that associates sticky information pasted onto the board, on the basis of start point information and direction information received by the first receiving unit; and

a display that displays a sticky information group associated by the associating unit so as to indicate the association on the board.

(B) The information processing device according to (A), additionally including:

a second receiving unit that receives sticky information transmitted from a client device;

wherein the associating unit associates sticky information received by the second receiving unit with any already associated sticky information, and

the display, on the basis of the direction information in a sticky information group associated by the associating unit, displays sticky information received by the second receiving unit on the board at a next position after last sticky information in that sticky information group.

(C) The information processing device according to (A) or (B), wherein

the first receiving unit receives wrapping point information indicating a wrapping point of the area, and second direction information from that wrapping point, and

the associating unit associates sticky information within an area determined on the basis of the wrapping point information and the second direction information.

(D) The information processing device according to any one of (A) to (C), wherein

the associating unit associates unassociated sticky information on the basis of either the direction information or the second direction information in an area of already associated sticky information.

(E) A non-transitory computer readable medium storing a program causing a computer to execute a process for processing information, the process including:

receiving information specifying an area for pasting sticky information onto a board, the information being at least start point information indicating a start point for pasting sticky information within that area, and direction information indicating a direction in which to paste sticky information in order from that start point;

associating sticky information pasted onto the board, on the basis of the received start point information and direction information; and

displaying an associated sticky information group so as to indicate the association on the board.

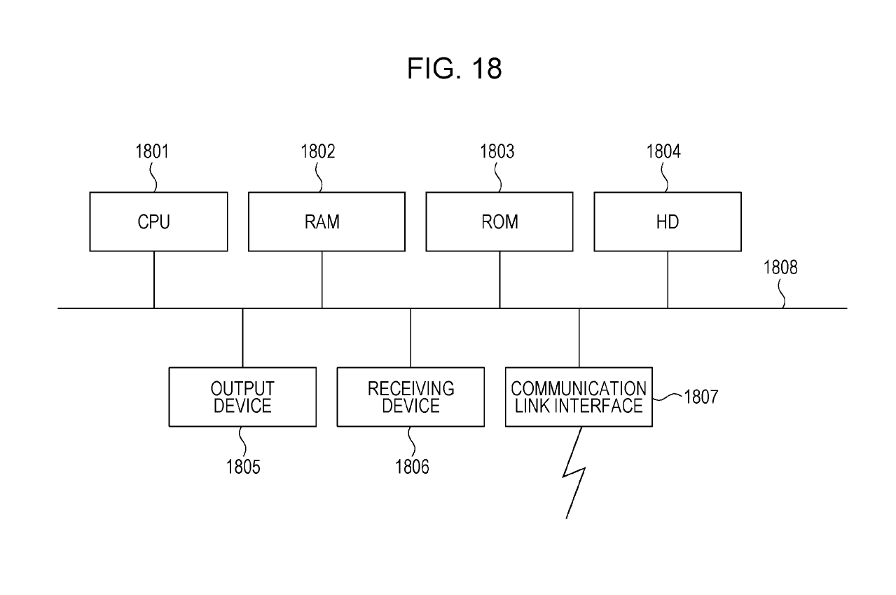

Note that a hardware configuration of a computer executing a program that acts as the present exemplary embodiment (such as the client device 100 or the display/placement device 150) is a general computer as illustrated by the example of FIG. 18, and specifically is a computer or the like that may be a personal computer or a server. In other words, as a specific example, a CPU 1801 is used as a processing unit (computational unit), while RAM 1802, ROM 1803, and an HD 1804 are used as storage devices. For the HD 1804, a hard disk may be used, for example. The computer is made up of the CPU 1801 that executes programs such as the receiving module 110, the active sticky display module 130, the communication module 120, the communication module 160, the association decision module 170, the participant position information acquisition module 180, the arrange command receiving module 1282, the place command receiving module 1284, and the display control module 190, the RAM 1802 that stores such programs and data, the ROM 1803 that stores programs and the like for activating the computer, the HD 1804 which is an auxiliary storage device, a receiving device 1806 that receives data on the basis of user operations with respect to a keyboard, mouse, touch panel, or the like, an image output device 1805 such as a CRT or liquid crystal display, a communication link interface 1807 such as a network interface card for connecting to a communication network, and a bus 1808 for joining and exchanging data with the above components. Multiple such computers may also be connected to each other by a network.

Of the foregoing exemplary embodiments, for those made up of a computer program, software in the form of a computer program is made to be read into a system with the above hardware configuration, and the foregoing exemplary embodiments are realized by the cooperative action of the software and hardware resources.

Note that the hardware configuration illustrated in FIG. 18 illustrates a single exemplary configuration, and that the exemplary embodiments are not limited to the configuration illustrated in FIG. 18 insofar as the configuration still enables execution of the modules described in the exemplary embodiments. For example, some modules may also be realized with special-purpose hardware (such as an ASIC, for example), and some modules may be configured to reside within an external system and be connected via a communication link. Furthermore, it may also be configured such that multiple instances of the system illustrated in FIG. 18 are connected to each other by a communication link and operate in conjunction with each other. Additionally, besides a personal computer in particular, an exemplary embodiment may also be incorporated into a device such as an information appliance, photocopier, fax machine, scanner, printer, or multi-function device (i.e., an image processing device having two or more from among scanning, printing, copying, and faxing functions).

Note that in the foregoing description of the exemplary embodiment, that which is taken to be “equal to or greater than”, “less than or equal to”, “greater than”, or “less than” in a comparison with a predetermined value may also be taken to be “greater than”, “less than”, “equal to or greater than”, or “less than or equal to”, respectively, insofar as the combination does not produce a contradiction.

Note that the described program may be provided stored in a recording medium, but the program may also be provided via a communication medium. In this case, a computer-readable recording medium storing a program, for example, may also be taken to be an exemplary embodiment of the present invention with respect to the described program.

A “computer-readable recording medium storing a program” refers to a computer-readable recording medium upon which a program is recorded, and which is used in order to install, execute, and distribute the program, for example.

Potential examples of a recording medium include a Digital Versatile Disc (DVD), encompassing formats such as DVD-R, DVD-RW, and DVD-RAM defined by the DVD Forum and formats such as DVD+R and DVD+RW defined by DVD+RW Alliance, a compact disc (CD), encompassing formats such as read-only memory (CD-ROM), CD Recordable (CD-R), and CD Rewritable (CD-RW), a Blu-ray Disc (registered trademark), a magneto-optical (MO) disc, a flexible disk (FD), magnetic tape, a hard disk, read-only memory (ROM), electrically erasable and programmable read-only memory (EEPROM (registered trademark)), flash memory, random access memory (RAM), and a Secure Digital (SD) memory card.

In addition, all or part of the above program may also be recorded to the recording medium and saved or distributed, for example. Also, all or part of the above program may be communicated by being transmitted using a transmission medium such as a wired or wireless communication network used in a local area network (LAN), a metropolitan area network (MAN), a wide area network (WAN), an internet, an intranet, an extranet, or some combination thereof, or alternatively, by being impressed onto a carrier wave and propagated.

Furthermore, the above program may be part of another program, and may also be recorded to a recording medium together with other separate programs. The above program may also be recorded in a split manner across multiple recording media. The above program may also be recorded in a compressed, encrypted, or any other recoverable form.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing device comprising:
an acquiring unit that acquires position information, being information indicating a position of a participant;
an extracting unit that processes sticky information being displayed on a shared screen, and extracts sticky information created by a participant near the shared screen, on the basis of position information acquired by the acquiring unit; and
a transmitting unit that transmits sticky information extracted by the extracting unit to a participant device as sticky information to display in order to associate sticky information created by a participant on the participant device.

2. The information processing device according to claim 1, wherein
in the case in which a participant who was near the shared screen moves away from the shared screen, the extracting unit extracts sticky information created by that participant, and
the transmitting unit transmits sticky information extracted by the extracting unit to the participant device so as to indicate sticky information to be removed from the participant device from among already transmitted sticky information.

3. An information processing device comprising:
an extracting unit that processes sticky information being displayed on a shared screen and extracts sticky information selected by a participant, or processes sticky information being displayed on the shared screen and extracts sticky information on the basis of attribute information of that sticky information; and
a transmitting unit that transmits sticky information extracted by the extracting unit to a participant device as sticky information to display in order to associate sticky information created by a participant on the participant device.

4. The information processing device according to claim 1, wherein
the transmitting unit, in the case of transmitting sticky information to the participant device to be displayed, adds and transmits a period during which to display the sticky information on the participant device.

5. The information processing device according to claim 4, wherein
the length of the period is set to a length based on an attribute of the sticky information to transmit.

6. The information processing device according to claim 1, further comprising:
a receiving unit that, in correspondence with a transmission by the transmitting unit, receives from the participant device first sticky information and identification information that identifies second sticky information associated with the first sticky information;
an associating unit that associates the first sticky information with the second sticky information of identification information received by the receiving unit; and
a display that displays first sticky information associated by the associating unit near the second sticky information on the shared screen.

7. The information processing device according to claim 1, further comprising:
a receiving unit that, in correspondence with a transmission by the transmitting unit, receives first sticky information from the participant device;
an associating unit that, on the basis of an attribute of the first sticky information of identification information received by the receiving unit, associates the first sticky information with any of the second sticky information transmitted by the transmitting unit; and
a display that displays first sticky information associated by the associating unit near the second sticky information on the shared screen.

8. The information processing device according claim 1, wherein
the extracting unit extracts a group including sticky information created by a participant near the shared screen, and
the transmitting unit transmits a group extracted by the extracting unit to the participant device.

9. The information processing device according to claim 8, further comprising:
a receiving unit that, in correspondence with a transmission by the transmitting unit, receives first sticky information from the participant device;
an associating unit that, on the basis of an attribute of the first sticky information of identification information received by the receiving unit, associates the first sticky information with any group transmitted by the transmitting unit; and
a display that displays first sticky information associated by the associating unit within an associated group on the shared screen.

10. An information processing method comprising:
acquiring position information, being information indicating a position of a participant;
processing sticky information being displayed on a shared screen, and extracting sticky information created by a participant near the shared screen, on the basis of acquired position information; and
transmitting extracted sticky information to a participant device as sticky information to display in order to associate sticky information created by a participant on the participant device.

11. A non-transitory computer readable medium storing a program causing a computer to execute a process for processing information, the process comprising:
acquiring position information, being information indicating a position of a participant;
processing sticky information being displayed on a shared screen, and extracting sticky information created by a participant near the shared screen, on the basis of acquired position information; and
transmitting extracted sticky information to a participant device as sticky information to display in order to associate sticky information created by a participant on the participant device.

12. A non-transitory computer readable medium storing a program causing a computer to execute a process for processing information, the process comprising:
processing sticky information being displayed on a shared screen and extracting sticky information selected by a participant, or processing sticky information being displayed on the shared screen and extracting sticky information on the basis of attribute information of that sticky information; and
transmitting extracted sticky information to a participant device as sticky information to display in order to associate sticky information created by a participant on the participant device.
